(19) United States
(12) Patent Application Publication
(10) Pub. No.: US 2006/0211813 A1
(43) Pub. Date: Sep. 21, 2006

(54) Phosphonic acid-modified microgel dispersion

(76) Inventor: Horst Mueller, Koln (DE)

Correspondence Address: FISH & RICHARDSON PC, P.O. BOX 1022, MINNEAPOLIS, MN, 55440-1022, US

(21) Appl. No.: 10/567,616

(22) PCT Filed: Aug. 5, 2004
(86) PCT No.: PCT/IB04/51403

§ 371 Date: Feb. 7, 2006

(30) Foreign Application Priority Data
Aug. 8, 2003 (DE) 10336770.5

(51) Int. Cl. C09D 5/02

(52) U.S. Cl. 524/556; 524/502

(57) ABSTRACT

Emulsifier-free microgel dispersed in the aqueous phase obtainable by producing a polyacrylate (A) in the presence of at least compound (B) exhibiting a phosphonic acid group, the polyacrylate (A) exhibiting at least one hydroxyl group and at least one carboxyl group, the reaction mixture originating from step b) not being subjected to subsequent emulsion polymerisation.

The present invention relates to a microgel and its use in a multilayer coating, in particular for mass-coating of motor vehicle bodies.

To mass-coat blank motor vehicle bodies, a multilayer coating of a total of four different layers (four layer structure) is usually used, these four layers being applied in separate coating facilities one after the other.

The first layer present directly on the vehicle sheet metal is a layer applied by electrophoresis (electrocoat layer, KDC layer) which is applied by electrodeposition—mainly cathodic dip coating (KDC)— for purposes of anticorrosion protection and subsequently stoved.

The second layer which is present on the electrocoat layer and approximately 30 to 40 μm thick is a so-called filler layer which, on the one hand, provides protection against mechanical attack (function of providing resistance to stone chipping) and, on the other hand, guarantees sufficient non-sagging properties, i.e. smoothes the rough surface of the blank vehicle body for subsequent top coat application and fills relatively small unevennesses. The paints used to produce these filler layers contain not only binders but also pigments. The wettability of the pigments used influences the non-sagging properties of the entire multilayer coating and also the gloss of the filler layer such as it is required by some motor vehicle manufacturers. The filler layer is produced largely by application with electrostatic high rotation bells and a subsequent stoving process at temperatures above 130° C.

The third layer present on the filler layer is the base coat layer which provides the vehicle body with the desired colour by corresponding pigments. The base coat is applied by the conventional spray process. The layer thickness of this conventional base coat layer is between approximately 12 and 25 μm, depending on the tint. Usually, this layer, particularly in the case of metallic paints, is applied in two process steps. In a first step, the application takes places by means of electrostatic high rotation bells followed by a second application by pneumatic atomisation. (When an aqueous base coat is used), this layer is dried in between by infra-red heaters and/or by hot air convection.

The fourth and uppermost layer present on the base coat layer is the clear coat layer which is usually applied by electrostatic high rotation bells in one application. It provides the vehicle body with the desired gloss and protects the base coat against environmental effects (UV radiation, salt water etc.)

Subsequently, the base coat layer and the clear coat layer are stoved together.

A water-dilutable base coat and/or a base coat layer produced therefrom which are suitable for use in this multilayer coating are required to satisfy further essential requirements, apart from the colour imparting properties:

On the one hand, the base coat layer must lead, in the cured state, to an optimum alignment of the aluminium flakes used as effect pigments. This characteristic known by the term “flip/flop” effect is of decisive importance for every metallic coating. A particularly satisfactory “flip/flop” effect is achieved when the platelet-type effect pigments are aligned as evenly as possible at a flat angle to the paint layer. A highly satisfactory aluminium orientation also contributes to the negative image of the so-called “cloud formation” not occurring.

Moreover, the base coat layer is required to exhibit an accurately defined adhesion to the pain layers present below and above it. Consequently, it is the base coat which has the decisive influence on the resistance to stone chipping of the resulting multilayer coating of motor vehicle bodies. In this connection, it should be noted that the resistance to stone chipping is a so-called “k.o. criterion”, i.e. only those multilayer coatings may be used in production operations which have previously passed the chipping test according to VDA. This test has been passed if the finished multilayer coating exhibits flaking in the case of an accurately defined mechanical stress which does not exceed a certain surface area and which is attributable to the separation of the base coat layer from the filler layer present underneath. Consequently, the adhesion of the base coat layer must be adjusted in such a way that, on the one hand, it is sufficiently high for the clear coat layer not to detach itself from it but sufficiently low for the filler layer not to be entrained in the case of stone chipping which otherwise would lead to considerable corrosion damage to the motor vehicle body.

On the other hand, the base coat must exhibit a satisfactory processability. This means that a layer thickness is achieved, if possible, in one spray application, which is such that a sufficient colour opacity is guaranteed. If a thickness of only 17 μm of the base coat layer is required for a sufficient colour opacity of the highly opaque tint, at least 45 μm are required for the less opaque tint of white. It still presents considerable problems to apply such a layer thickness using a spray process since corresponding rheological properties of the water-dilutable base coat need to be available.

In the case of base coats with metallic effect pigments, the problems described above of guaranteeing sufficient non-sagging properties in the case of the usual layer thickness of approximately 18 μm are particularly pronounced. Silver metallic is a particularly critical tint in this connection.

The term “rheological properties” should be understood to mean that, on the one hand, the paint has such a low viscosity during the spray process, i.e. at high shear rates, that it can be atomised easily and, on the other hand, it has such a high viscosity on impacting onto the substrate, i.e. at low shear rates, that it is sufficiently non-sagging and exhibits no runs. The greater the layer thickness is supposed to be, the greater is the problem of reconciling these contradictory properties. The formation of a distinct metallic effect, too, is connected with these properties.

These basic problems are also possibly the reason why numerous printed articles concern themselves with specifically designed binder systems or with specific additives for water-dilutable base coats.

To improve the rheological properties and for an improved formation of the metallic effect, special additives are described (EP 0 281 936). These are special layer silicates which contain considerable quantities of alkali ions or alkaline earth ions. Because of their water-attracting effect, these ions frequently lead to a poor resistance to condensation in the overall structure of a motor vehicle coating.

Efforts have consequently been made by the paint manufacturer to avoid such additives as far as possible and to use those polymers as binders which inherently provide the desired properties, the so-called “tailor-made” polymers.

One of the most important representatives of this species are crosslinked polymer microparticles present in aqueous dispersion which are also abbreviated to “microgels”. The addition of microgels causes not only an improvement in the rheological properties but also considerably influences the non-sagging properties of the paint to be applied, the alignment of the effect pigments and the adhesion of the base coat on the filler layer underneath and consequently exerts a decisive influence on the resistance to stone chipping of the multilayer coating. However, it has to be admitted, that the addition of microgels does not influence positively all the properties mentioned above.

Particular microgels are known from EP 0 030 439 B1 and EP 0 242 235 A1. The aqueous microgel dispersions described therein as advantageous also for metallic paint coatings are, however, not completely crosslinked microgels but belong to the so-called “core/shell” microgels.

The term “core/shell structure” should be understood to mean that the polymer particle is formed essentially of two different areas: the inner area (core) is surrounded by an outer area (shell), these areas having a different chemical composition and consequently also different physical properties.

The core of this microgel is obtainable from a mixture containing, apart from monofunctional monomers also difunctional monomers. Crosslinking takes place using an emulsifier. Subsequently, this microparticle crosslinked in this way is coated and grafted according to EP 0 030 439 B1 with a layer of non-crosslinked acrylic polymer. According to EP 0 242 235 A1, the crosslinked microparticle is coated with a layer of polymerisable aromatic compounds.

Moreover, it is described in EP 0 030 439 B1 to convert the microgels present in aqueous dispersion into a non-aqueous phase and to use it for solvent-containing coating compositions. From EP 0 038 127 B1, EP 0 029 637 A1 and GB 2 159 161 A, microgels are known which are obtainable by the polymerisation of suitable polymers in the presence of an emulsifier, e.g. N,N-bis(hydroxyethyl)taurine.

The term “emulsifier” should be understood to mean those compounds which exhibit both a hydrophilic and a hydrophobic radical. Emulsifiers effect a stabilisation of emulsions, i.e. of disperse systems of two non-miscible or only partially miscible liquids or phases, one of which is finely dispersed in the other. A more detailed definition of such compounds can be found e.g. in “Römpp Chemie Lexikon” (volume 2, edition 8, 1981, page 1126-1127). In general, a distinction is made between ionic, non-ionic and amphoteric emulsifiers. For colour imparting coating compositions, emulsifiers are used which exhibit, as hydrophilic radical, a group originating from sulphonic acid and, as hydrophobic radical, a longer-chain fatty acid alkyl radical.

A major disadvantage of the microgels produced using an emulsifier consists of the fact that the emulsifier remains in the finished microgel since the latter—e.g. as a result of sulphur-containing groups present in the emulsifier (sulphonic acid groups)—can thus be used for numerous applications only with considerable drawbacks. Thus, such microgels have negative properties as a result of the emulsifier contained therein, e.g. with respect to their use in water-dilutable base coats in the motor vehicle industry, in particular with respect to storage in water and resistance to condensation.

EP-0 502 934, too, describes a microgel dispersion. This is used both to improve the rheological properties and to increase the gassing stability of aqueous metallic base coats. The production of these microgel dispersions takes place by a single stage polycondensation of a polyester polyol with an aminoplast resin (melamine resin) in the aqueous phase.

The use of this microgel in base coats for coating motor vehicle bodies, however, also has the disadvantage that the adhesion between the base coat layer and a clear coat layer present thereon and applied from a clear powder coat or a clear powder coating slurry does not satisfy the requirements specified by the motor vehicle industry.

Moreover, microgels are known from DE 195 04 015 A1 which are produced by the polymerisation of an ethylenically monofunctional compound (polyacrylate) with at least one ethylenically difunctional or multifunctional compound in the presence of a polyester. In this case, the polyester acts as emulsifier and stabiliser.

These microgels have the disadvantage that the rheological properties of these paints no longer satisfy the more stringent requirements of the motor vehicle industry. This is particularly evident with respect to the requirements regarding the viscosity, on the one hand, and the non-sagging properties, on the other hand.

Thus, it is not possible, when using these microgels, to provide an aqueous base coat which has a viscosity of maximum 120 mPa·s with a shear rate of 1,000 s⁻¹ and, simultaneously, is non-sagging to such an extent that the necessary layer thicknesses of 20-30 μm (possibly less or more, depending on the tint) can be achieved without runs.

Moreover, microgels are known from WO 00/63265 and WO 00/63266 which are obtainable from a multi-stage polymerisation process, a polymerisation of ethylenically monofunctional compounds being carried out in a first step with ethylenically difunctional or multifunctional compounds in the presence of a polyester polyol, polyurethane and/or polyacrylate. As final step, the product thus contained is reacted with a crosslinking agent. However, the risk of gelling taking place has become apparent during the reaction of trimellitic acid or its anhydride with the poly(meth)acrylate.

The object of the present invention consists of providing a water-dilutable microgel which can be used in water-dilutable base coats, in particular for the motor vehicle industry. The multilayer coatings obtainable therefrom should overcome the disadvantages of the state of the art described above; in particular, the colour imparting layer should exhibit a sufficient resistance to clouding and the overall level of characteristics of the finished multilayer coating should satisfy the stringent requirements of the motor vehicle manufacturers (in particular with respect to appearance and resistance to stone chipping).

In addition, this microgel should be highly compatible in particular with binder systems based on polyurethanes and polyacrylates and provide particularly high quality coatings.

This object is achieved according to the invention by an emulsifier-free microgel dispersed in the aqueous phase obtainable by
a) producing a polyacrylate (A) in the presence of at last one compound (B) exhibiting a phosphonic acid group, the polyacrylate (A) exhibiting at least one hydroxyl group and at least one carboxyl group;
b) crosslinking, in the aqueous phase, of the reaction mixture originating from step a) with an aminoplast resin (C);
the reaction mixture originating from step b) being not subjected to any subsequent emulsion polymerisation.

Before step b), the polyacrylate (A) resulting from step a) can be subjected to emulsion polymerisation with at least one monomer compound (D), the monomer compound (D) containing at least one free radical polymerisable double bond.

A coating composition containing this emulsifier-free microgel dispersion exhibits such an excellent adhesion that it can also be used in multilayer coatings considered critical, in particular in combination with powder clear coats in motor vehicle coating in series.

The presence of the phosphonic acid group during reaction step a) guarantees that, in the aqueous phase, the mixture obtainable from step a) reacts with the aminoplast resin(s) in step b) to form a microgel dispersion, i.e. that crosslinked particles are formed without the stability of the dispersion being impaired. Thus, the coagulation of the dispersion is effectively avoided.

In contrast to the known processes of the state of the art, no trimellitic acid or its anhydrides is used in any of the embodiments according to the invention. These compounds have the decisive disadvantage that they considerably increase the danger of gelling during the manufacture of microgels in a reaction with a poly(meth)acrylate.

The conversion to the microgel according to the invention is possible irrespective of a pH of the reaction mixture common for water-dilutable coating compositions. Crosslinking is thus guaranteed irrespective of the degree of neutralisation: crosslinking takes place even with a degree of neutralisation of 100%, even with a melamine resin, e.g. hexamethoxymethyl melamine, which is inert at low stoving temperatures (i.e. of less than 100° C.). In comparison, the degree of neutralisation has a considerable influence on the crosslinking reaction during the manufacture of microgel dispersions according to the state of the art: crosslinking is reduced, if not prevented completely, with a rising degree of neutralisation.

As a result of the particular method of producing the microgel according to the invention, it is, moreover, possible to select the solvents necessary for the production of the polyacrylate (A) or (E) in such a way that they can remain in the coating composition ready for application. The complicated and time-consuming removal of the solvents required for polymerisation consequently becomes unnecessary. Butyl glycol is particularly advantageous as solvent in this connection.

The degree of crosslinking of the microgels is recognisable by the content of insoluble fractions. The insoluble fractions are determined by means of the so-called “THF method”. For this purpose, approximately 1 g of the microgel dispersion is weighed into a centrifuge tube, 10 ml of tetrahydrofuran are added and homogenisation in an ultrasonic bath is carried out for approximately 1 minute. Subsequently, centrifuging is carried out with a centrifuge with a fixed angle rotor for 15 minutes at 13,500 rpm. Subsequently, the supernatant liquor is carefully removed by decanting and the tube is dried in a laboratory oven at 105° C. for 6 h. After cooling the tube, the residue is weighed. The insoluble proportions are calculated according to the following formula:

$$\% insoluble fractions \frac{Residue * 10000}{ \begin{matrix}amount weighed in * \% solids \\ content of the microgel dispersion\end{matrix}}$$

The term “largely crosslinked” should be understood to mean those microgels which exhibit a proportion of non-crosslinked polymers of not more than 50% by weight, based on the crosslinked part.

The emulsifier-free and phosphonic acid-modified microgel according to the invention is present in an aqueous dispersion and provides coating compositions containing this microgel dispersion with an increased structural viscosity in such a way that a satisfactory resistance to sagging is guaranteed during application, the resulting coating compositions being hardenable both chemically and physically.

Within the framework of the present invention, the property “aqueous” means that the dispersions according to the invention contain no or only minor quantities of organic solvents. Minor quantities are those quantities which do not destroy the aqueous nature of the dispersions according to the invention.

The property “structurally viscous” means that the coating compositions containing these emulsifier-free microgel dispersions exhibit a viscosity which is lower, with higher shear stresses or higher velocity gradients than at low values (compare Römpp Lexikon Lacke and Druckfarben, Georg Thieme Verlag, Stuttgart, N.Y., 1998, page 546, “Strukturviskosität (structural viscosity)”).

This structural viscosity is not dependent on time. This non-dependence on time means that the change in viscosity as a function of the shear rate is identical both with an increasing shear rate and with a decreasing shear rate.

This structurally viscous behaviour takes into account, on the one hand, the requirements of spray application and, on the other hand, also the requirements regarding storage stability and resistance to settling out.

In the agitated state, e.g. during pumping of a coating composition containing the microgels according to the invention in the angular line of the coating facility and on spraying, the coating composition assumes a state of low viscosity which guarantees a satisfactory processability. Without shear stress, on the other hand, the viscosity increases and guarantees in this way that the coating composition already present on the substrate surface has a reduced tendency to running off vertical surfaces (“formation of runs”). In the same way, the higher viscosity in the non-agitated state such as during storage, leads to settling out of solid components, such as pigments which may be present, being largely prevented or a re-agitation of the solid components which have settled only slightly during storage is guaranteed.

Within the framework of the present invention, the term “physical hardening” means hardening of a layer of a coating substance by film formation by release of solvent from the coating substance, interlinking taking place within the coating via loop formation of the polymer molecules of the film-forming component or the binder (regarding the term compare Römpp Lexikon Lacke und Druckfarben, Georg Thieme Verlag, Stuttgart, N.Y., 1998 “Bindemittel” (binders), page 73 and 74). Or the film formation takes place via the coalescence of binder particles (compare Römpp Lexikon Lacke und Druckfarben, Georg Thieme Verlag, Stuttgart, N.Y., 1998 “Hartung” (Hardening), pages 274 and 275). Usually, no crosslinking agents are necessary for this purpose. If necessary, physical hardening can be promoted by heat or the effect of actinic radiation.

In contrast, the term “chemical hardening” means hardening of a layer of a coating substance by chemical reaction (compare “Härtung von Kunststoffen” (Hardening of polymers) in Römpp Chemie Lexikon, edition 8, 1989, page 1602 ff.)

Usually, chemical hardening is achieved by means of atmospheric oxygen or crosslinking agents.

According to a preferred embodiment of the present invention, the polyacrylate (A) is obtainable by the polymerisation
of a monomer (i) with at least one polymerisable double bond and at least one hydroxyl group;
of a monomer (ii) with at least one polymerisable double bond and at least one carboxyl group; and
of a monomer (iii) without hydroxyl group and without carboxyl group with at least one polymerisable double bond.

The crosslinking density can be adjusted by means of the quantity of monomers containing hydroxyl groups. In the case of a small quantity of monomers containing hydroxyl groups, depending on the molecular weight of the polymer, the crosslinking points are widely spaced. By increasing the quantity of monomers containing hydroxyl groups, the crosslinking points are arranged more densely. In this way, both the orientation of the effect pigments, the non-sagging properties and the rheology of the coating composition containing the emulsifier-free microgel dispersion according to the invention are positively influenced.

The stability of the microgel dispersion in water is influenced positively by a sufficient amount of monomer ii). However, the quantity of ii) should not be selected too high since, otherwise, the resistance to condensation is reduced.

According to a further embodiment of the present invention which is also preferred, compound (B) is an adduct of an alkyl phosphonic acid with a compound containing epoxy groups.

As an example of a suitable alkyl phosphonic acid, octyl phosphonic acid can be mentioned. As an example of compounds containing epoxy groups, adducts of glycidyl esters of a monocarboxylic acid branched in α-position with 5 to 18 carbon atoms per molecule with phosphonic acid can be mentioned. A particularly preferred glycidyl ester is marketed under the trade name of Cardura® E10 by Resolution.

The choice of these starting compounds guarantees pH independence during crosslinking in a particularly effective manner.

The object of the present invention is also achieved by an emulsifier-free microgel dispersed the in aqueous phase obtainable by
a) producing a polyacrylate (E) by the copolymerisation
   of a monomer (i) with at least one polymerisable double bond and at least one hydroxyl group;
   of a monomer (ii) with at least one polymerisable double bond and at least one carboxyl group; and
   of a monomer (iv) with at least one polymerisable double bond and at least one phosphonic acid group;
b) crosslinking, in the aqueous phase, of the reaction mixture originating from step a) with an aminoplast resin (C);
the reaction mixture originating from step b) being not subjected to any subsequent emulsion polymerisation.

Before step b), polyacrylate (A) resulting from step a) can be subjected to an emulsion polymerisation with at least one monomer compound (D) which contains at least one free radical polymerisable double bond.

According to this embodiment, the emulsifier-free and phosphonic acid-modified microgel according to the invention is also present in an aqueous dispersion and provides coating compositions containing these microgel dispersions with an increased structural viscosity such that sufficient non-sagging properties are guaranteed during application.

A particular advantage of all emulsifier-free and phosphonic acid-modified microgels according to the invention corresponding to the embodiments described above consists in that their addition to water-dilutable coating compositions causes a substantial and positive improvement in specific properties.

Basically, it can be said that the rheological properties of the water-dilutable coating compositions obtainable by using this emulsifier-free and phosphonic acid-modified microgel dispersion are improved compared with those of the state of the art. Thus, a water-dilutable base coat usable in the motor vehicle industry, for example, exhibits, on addition of 20% of emulsifier-free microgel dispersion according to the invention—based on the solids content of the coating composition—a viscosity of maximum 100 mPa·s with a shear rate of 1,000 s⁻¹, the thickness of the dry film of the cured base coat layer being 22 μm, without runs being observable.

The emulsifier-free and phosphonic acid-modified microgel according to the invention is suitable to a particular extent for the production and formulation of water-dilutable base coats, in particular for those used in the motor vehicle industry.

In addition, the emulsifier-free and phosphonic acid-modified microgel dispersion according to the invention of the colour imparting coating composition has an excellent application guarantee, in particular with respect to resistance to clouding.

Moreover, as a result of the addition of the emulsifier-free and phosphonic acid-modified microgel dispersion according to the invention to colour imparting coating compositions, the overall property level of the finished multilayer coating is not negatively influenced. Thus, the finished multilayer coating exhibits excellent properties with respect to mechanical influences (resistance to stone chipping).

Moreover, the emulsifier-free and phosphonic acid-modified microgel dispersions according to the invention can be found to have an excellent usability in combination with binder systems based on polyurethanes, polyacrylates or mixtures of polyurethanes and polyacrylates. This good usability is shown in particular by the good adhesion properties of the resulting paint film on plastic substrates. Coating compositions of a combination of binder systems based on polyurethanes and/or polyacrylates and the emulsifier-free microgel dispersions according to the invention provide very high quality coatings.

In a further embodiment of the present invention which is also preferred, the copolymerisation is carried out in the presence of an additional monomer (iii) without a hydroxyl group and without a carboxyl group, which monomer exhibits at least one polymerisable double bond.

The crosslinking density can be adjusted by means of the quantity of monomer containing hydroxyl groups. With a small quantity of monomers containing hydroxyl groups, depending on the molecular weight of the polymer, the crosslinking points are widely spaced. By increasing the quantity of monomer containing hydroxyl groups, the crosslinking points are arranged more densely. As a result, the orientation of the effect pigments, the non-sagging properties as well as the rheology of the coating composition containing the emulsifier-free microgel dispersion according to the invention are positively influenced.

The monomer (i) can be selected from the hydroxy alkyl esters of acrylic acid, methacrylic acid or another α,β-olefinically unsaturated carboxylic acid derived from an alkylene glycol which is esterified with the acid or which is obtainable by the reaction of the α,β-olefinically unsaturated carboxylic acid with an alkylene oxide such as ethylene oxide or propylene oxide, in particular hydroxy alkyl esters of acrylic acid, methacrylic acid, ethylacrylic acid, crotonic acid, maleic acid, fumaric acid or itaconic acid, in which the hydroxy alkyl group contains up to 20 carbon atoms, such as 2-hydroxyethyl acrylate, 2-hydroxypropyl acrylate, 3-hydroxypropyl acrylate, 3-hydroxybutyl acrylate, 4-hydroxybutyl acrylate, -methacrylate, -ethacrylate, -crotonate, -maleinate, -fumarate or -itaconate; or hydroxycycloalkyl esters such as 1,4-bis(hydroxymethyl)cyclohexane acrylate, octahydro-4,7-methano-1H-indene dimethanol acrylate or methylpropane diol monoacrylate, -monomethacrylate, -monoethacrylate, -monocrotonate, -monomaleinate, -monofumarate or -monoitaconate.

Reaction products of cyclic esters such as e.g. caprolactone and the hydroxy alkyl esters or hydroxy cycloalkyl esters described above (obtainable e.g. under the trade name Tone® M 100 from DOW Chemicals) can also be used.

Preferably, the monomer (i) is selected from the group of hydroxyethyl(meth)acrylate, hydroxypropyl(meth)acrylate, hydroxybutyl(meth)acrylate and caprolactone esterified on the basis of hydroxy(meth)acrylate.

The monomer (ii) can be selected from the group of acrylic acid, methacrylic acid, ethacrylic acid, crotonic acid, maleic acid, fumaric acid or itaconic acid.

Preferably, the monomer (ii) is selected from the group of acrylic acid and methacrylic acid.

With respect to the monomer (iii) this can be
vinyl aromatic compounds such as e.g. vinyl toluene, α-methyl styrene, p-, m- or p-methyl styrene, 2,5-dimethyl styrene, p-methoxy styrene, p-tert.-butyl styrene, p-dimethylaminostyrene, p-acetamidostyrene and m-vinyl phenol, particularly preferably styrene;
esters of acrylic or methacrylic acid such as methyl(meth)acrylate, ethyl(meth)acrylate, butyl(meth)acrylate, iso-butyl(meth)acrylate, tert.-butyl(meth)acrylate, isopropyl(meth)acrylate, pentyl(meth)acrylate, isoamyl(meth)acrylate, hexyl(meth)acrylate, α-ethylhexyl(meth)acrylate, furfuryl(meth)acrylate, octyl(meth)acrylate, 3,5,5-trimethylhexyl(meth)acrylate, decyl(meth)acrylate, lauryl(meth)acrylate, hexadecyl(meth)acrylate, octadecyl(meth)acrylate, stearyl(meth)acrylate and ethyltriglycol(meth)acrylate; cyclohexyl(meth)acrylate, isobornyl(meth)acrylate;
aminoethyl acrylate, aminoethyl methacrylate, allylamine, N-methyliminoethyl acrylate or tert.butylaminoethyl methacrylate;
N,N-di(methoxymethyl)aminoethyl acrylate or N,N-di(methoxymethyl)aminoethyl methacrylate or N,N-di(butoxymethyl)amino propyl acrylate or N,N-di(butoxymethyl)amino propyl methacrylate;
(Meth)acrylic acid amides such as (meth)acrylic acid amide, N-methyl acrylic acid amide, N-methylol acrylic acid amide, N-dimethylol acrylic acid amide, N-methoxymethyl acrylic acid amide, N,N-di(methoxymethyl)acrylic acid amide, N-ethoxymethyl acrylic acid amide and/or N,N-di(ethoxyethyl)(meth)acrylic acid amide;
Acryloyloxy or methacryloyloxyethyl carbamate, propyl carbamate or butyl carbamate or -allophanate; other examples of suitable monomers containing carbamate groups are described in patent specifications U.S. Pat. No. 3,479,328, U.S. Pat. No. 3,674,838, U.S. Pat. No. 4,126,747, U.S. Pat. No. 4,279,833 or U.S. Pat. No. 4,340,497.
Monomers containing epoxy groups such glycidyl esters of acrylic acid, methacrylic acid, ethacrylic acid, crotonic acid, maleic acid, fumaric acid or itaconic acid or allyl glycidyl ether.
Ethylenically difunctional or multifunctional compounds, preferably diacrylates, triacrylates and/or (meth)acrylic acid esters of polyfunctional alcohols, in particular allyl(meth)acrylate, hexane diol di(meth)acrylate, ethylene glycol di(meth)acrylate, neopentyl glycol di(meth(acrylate, butane diol di(meth)acrylate or trimethylol propane tri(meth)acrylate.

Preferably, the monomer (iii) is selected from the group of acrylic (meth)acrylic acid esters free from hydroxyl groups and styrene.

In the case of compounds free from hydroxyl groups, those of the above-mentioned monomers (iii) can be used as monomer compound (D); in the case of compounds containing hydroxyl groups, those of the above-mentioned monomer (i) can be used.

Preferably, the monomer (iv) is vinyl phosphonic acid.

Examples of aminoplast resins are described, for example, in Römpp Lexikon Lacke and Druckfarben, Georg Thieme Verlag, 1998, page 29, “Aminoharze” (Amino resins), the handbook “Lackadditive” (Paint additives) by Johan Bieleman, Wiley-VCH, Weinheim, N.Y., 1998, page 242 ff, the book “Paints, Coatings and Solvents”, second completely revised edition, edit. D. Stoye and W. Freitag, Wiley-VCH, Weiheim, N.Y., 1998, pages 80 ff, the patent specifications U.S. Pat. No. 4,710,542 A or EP 0 245 700 A1 and the article by B. Singh et al “Carbamylmethylated Melamines, Novel Crosslinkers for the Coatings Industry”, in Advanced Organic Coatings Science and Technology Series, 1991, volume 13, pages 193 to 207.

Preferably, the aminoplast resin is a melamine resin as marketed by Cytec, for example, under the trade name Cymel® 327.

According to a further embodiment of the present invention which is also preferred, the monomer compound (D) used in emulsion polymerisation exhibits at least one hydroxyl group.

In addition, a coating composition containing this emulsifier-free microgel dispersion exhibits an excellent adhesion such that it can be used also in multilayer coating considered as critical, in particular in combination with powder clear coats in motor vehicle mass-coatings.

According to an embodiment of the present invention which is also preferred, the microgel has an acid number of between 10 and 45 mg KOH/g.

As a result, a satisfactory stability of the dispersion in water is guaranteed.

From the methodology point of view, this polymerisation exhibits no particularities but takes place according to the common and known methods of free radical emulsion polymerisation in the presence of at least one polymerisation initiator.

Examples of suitable polymerisation initiators are initiators forming free radicals such as dialkyl peroxides such as di-tert.butyl peroxide or dicumyl peroxide; hydroperoxides such as cumene hydroperoxide or tert.butyl hydroperoxide; peresters such as tert.butyl perbenzoate, tert.butyl perpivalate, tert.butyl per-3,5,5-trimethyl hexanoate or tert.butyl per-2-ethyl hexanoate; potassium peroxydisulphate, sodium peroxydisulphate or ammonium peroxydisulphate; azodinitriles such as azobisisobutyronitrile; C-C splitting initiators such as benzopinacol silyl ether or a combination of a non-oxidising initiator with hydrogen peroxide. Preferably, water-insoluble initiators are used. Preferably, the initiators are used in a quantity of 0.1 to 25% by weight, particularly preferably of 0.75 to 10% by weight, based on the total weight of the monomer.

The polymerisation initiation by a redox system is one possibility. This process well known in the field of emulsion polymerisation technology makes use of the fact that hydroperoxides can be induced to radical decomposition by suitable reducing agents even at very low temperatures.

Suitable reducing agents are, for example, sodium metabisulphite or its formaldehyde addition products (Na hydroxymethane sulphinate). Isoascorbic acid is also highly suitable. The combination of tert.butyl hydroperoxide, (iso)ascorbic acid and iron(II)sulphate is particularly advantageous.

The use of this mixture has the advantage that the polymerisation can be started at room temperature.

The corresponding monomers are then polymerised in the solutions or the aqueous emulsions by means of the above-mentioned radical forming initiators at temperatures of 30 to 95° C., preferably 40 to 95° C. and using redox systems at temperatures of 35 to 90° C. When working under excess pressure, the emulsion polymerisation can be carried out also at temperatures above 100° C.

The same applies to solution polymerisation if higher-boiling organic solvents and/or excess pressure are used.

It is preferred to begin with the initiator introduction sometime, in general approximately 1 to 15 minutes, before the introduction of the monomer. Moreover, a process is preferred in the case of which the addition of initiator begins at the same time as the addition of the monomer and is terminated approximately half an hour after the addition of the monomer has been terminated. Preferably, the initiator is added in a constant quantity per unit of time. After terminating the initiator addition, the reaction mixture is maintained at the polymerisation temperature for long enough (as a rule for 1 to 1.5 hours) until all monomers used have been reacted essentially completely. “Reacted essentially completely” is to mean that, preferably, 100% by weight of the monomers used have been converted but that it is also possible for a small residual monomer content of maximum up to approximately 0.5% by weight, based on the weight of the reaction mixture, to remain in the unreacted state.

Suitable reactors for graft copolymerisation are the usual and known agitated vessels, agitated vessel cascades, tubular reactors, loop reactors or Taylor reactors such as those described, for example, in patent specification DE 10 71 241 B1, the patent applications EP 0 498 583 A1 or DE 198 28 742 A1 or in the article by K. Kataoka in Chemical Engineering Science, volume 50, section 9, 1995, pages 1409 to 1416.

The emulsifier-free microgel dispersion described above is particularly suitable according to the invention for the production of a multilayer coating, in particular in the motor vehicle industry.

The use of the emulsifier-free microgel dispersion in the colour imparting coating composition, i.e. a base coat, is particularly preferred.

The best results regarding the Theological, mechanical and optical properties are achieved if the proportion of microgel, based on the solids of the layer obtainable therefrom, is between 20 and 85%, preferably between 20 and 65%.

It is also surprising that the emulsifier-free microgel dispersions according to the invention can be used in water-dilutable base coats side by side with the usual layer silicates. In this case, the resulting coating paints do not exhibit the unsatisfactory resistance to condensation in compared with base coats without the addition of the microgel dispersion according to the invention.

For use according to the invention, the multilayer coating can consist of three different layers, i.e. of
1) a first layer present on the electrically conductive substrate and consisting of an electrophoretically deposited coating agent;
2) a second, colour imparting layer obtainable from a water-dilutable coating composition which contains the emulsifier-free microgel dispersion according to the invention; and
3) a third layer of a clear coat.

In the case of this multilayer coating consisting in particular of only three different layers, it should be emphasised that the resulting multilayer coating exhibits also a satisfactory resistance to stone chipping which is attributable to the particular properties of the water-dilutable base coat containing the emulsifier-free microgel of the present invention.

It is also possible for the multilayer coating to consist of four different layers, i.e. of
1) a first layer present on the electrically conductive substrate and consisting of an electrophoretically deposited coating agent;
2) a second layer of a primer and a filler;
3) a third, colour imparting layer obtainable from a water-dilutable coating composition which contains the emulsifier-free microgel dispersion according to the invention; and
4) a fourth layer of a clear coat.

An advantage of this four layer structure is that the cured colour imparting layer influences the properties protecting against stone chipping of the filler layer further in a positive manner.

By using the emulsifier-free microgel according to the invention, a much greater layer thickness—compared with conventional base coats—can be achieved. The thickness of the cured layer produced from a coating composition containing the emulsifier-free microgel dispersion according to the invention can be between 15 and 55 μm.

The coating agents to be deposited electrophoretically can be aqueous coating compositions with a solids content of approximately 10 to 20% by weight, usually containing binder, a ionic substituent or substituents convertible into ionic groups and groups capable of chemical crosslinking as well as pigments and other usual additives.

Examples of such electrodeposition paints are described in DE 28 24 418 A1, DE 33 24 211 A1, EP 0 082 291, EP 0 178 531, EP 0 227 975, EP 0 234 395, EP 0 245 786, EP 0 261 385, EP 0 310 971, EP 0 333 327, EP 0 414 199, EP 0 456 270, EP 0 476 514 and U.S. Pat. No. 3,922,253.

The clear coat layer which, in the case of a multilayer coating for motor vehicles, can be arranged above the colour imparting base coat, can be obtained by applying and stoving a common solvent containing or aqueous clear coat composition which is present as a one-component or two-component mixture and contains one or several basic resins as film forming binder. If the binder is not self-crosslinking, the clear coat composition can also contain crosslinking agents. Polyester resins, polyurethane resins and/or poly(meth)acrylate resins, for example, can be used as film-forming binders (basic resins).

Apart from the chemically crosslinking binders and, if necessary, crosslinking agents, these clear coats may contain the usual coating agent auxiliaries such as catalysts, levelling agents and light stabilisers.

Examples of solvent-containing clear coat compositions in one-components or two-component mixtures are described in DE 38 26 693 A1, DE 40 17 075 A1, DE 41 24 167 A1, DE 41 33 704 A1, DE 42 04 518 A1, DE 42 04 611 A1, EP 0 257 513, EP 0 408 858, EP 0 523 267 and EP 0 557 822.

Examples of aqueous clear coat compositions in one-component or two-component mixtures are described in DE 39 10 829 A1, DE 40 09 931 A1, DE 40 09 932 A1, DE 41 01 696 A1, DE 31 32 430 A1, DE 41 34 290 A1, DE 42 03 510 A1, EP 0 365 098, EP 0 365 775, EP 0 469 079 and EP 0 546 640, in particular in DE 44 19 216 A1 and DE 44 42 518 A1.

The clear coat layer can also be produced from a powder clear coat or a powder clear coat slurry.

With respect to the clear powder paint or clear powder paint slurry, reference is made to DE42 22 194 A1, DE 42 27 580 A1, EP 0 509 392, EP 0 509 393, EP 0 522 648, EP 0 544 206, EP 0 555 705, EP 0 652 265, EP 0 666 779 and EP 0 714 958.

However, it is also possible to convert the microgel dispersion according to the invention into a non-aqueous phase and to use it in solvent-containing coating compositions.

In order to obtain microgels in the non-aqueous phase, the water must be removed from the microgels according to the invention present in the aqueous phase.

This can be effected by any known process, e.g. by spray drying, freeze drying or evaporation, if necessary under reduced pressure.

After removal of the water, the microgel according to the invention may be present in powder form or as a resin-type mass.

According to a preferred variant, the microgel present in the aqueous phase is converted into a liquid organic phase. This can be effected by azeotropic distillation. In this case, one can proceed in such a way that the aqueous, emulsifier-free microgel dispersion is introduced continuously or batch-wise into a reactor at elevated temperature, if necessary under reduced pressure, which reactor contains an entraining agent, i.e. a solvent or a mixture of several solvents, at least one of which forms an azeotrope with water.

The reactor is equipped with a suitable condensing device and a water separator with a return flow to the reactor. After reaching the boiling temperature of the azeotrope, the gaseous azeotropic phase (i.e. the entrainment agent and water) rises into the condensing device. The azeotrope condenses therein and flows from there into the water separator. In the water separator, a phase separation takes place between the entrainment agent and the water. In the case of an azeotropic distillation carried out continuously, the entrainment agent flows back into the reactor such that only small amounts of entrainment agent need to be used. The water obtained from the water separator is free from organic components and can be used again for the production of the aqueous microgel dispersion according to the invention.

The entrainment agent can be selected from the group of xylene, butyl acetate, methyl isobutyl ketone, methyl amyl ketone, pentanol, hexanol or ethyl hexanol.

An essential advantage in this respect is that, after converting it into the organic phase, the entrainment agent remains therein and is advantageous for the use of solvent-containing coating compositions. Regarding the further use these microgels present in the organic phase for the production of solvent-containing coating compositions, the above-mentioned entrainment agents are suitable solvents.

As a result of the simultaneous reuse of the entrainment agent and the arising water without additional process steps, this process is characterised by an extraordinary degree of environmental compatibility, since no by-products to be disposed of are formed which arise in large quantities in comparison with known production processes.

In a particular form of azeotropic distillation, this is carried out in such a way that the aqueous, emulsifier-free microgel dispersion is introduced into a mixture of an entrainment agent and a high-boiling organic solvent. This high-boiling organic solvent prevents caking of the microgels to the wall of the reactor during conversion into the organic phase.

The high-boiling solvent can be selected from the group of glycol esters such as e.g. butyl glycol acetate and/or butyl diglycol acetate.

As in the case of the entrainment agent, the high-boiling solvent is also a component commonly used for a solvent-containing coating composition.

The microgel obtainable in this way can be used in particular for solvent-containing coating compositions.

A preferred form of use of the invention is the application in solvent-containing base coats, in particular effect base coats and clear coats, for top coats and/or coating of motor vehicles.

This microgel present in the organic phase provides these solvent-containing coating compositions also with an excellent application behaviour and superb decorative properties which manifest themselves, for example, by way of a distinct metallic effect, an excellent resistance to running vertically (SCA—sagging control agent), freedom from clouding, resistance to redissolution by clear coat, good coverage of polishing grooves and satisfying the property requirements common in the motor vehicle industry.

The microgels can be used equally well for the production of solvent-containing clear coats, coil coating compositions and stoving paints for industrial applications as well as coating paints for the construction sector.

A further particularity of this microgel consists of its very high resistance to shear stress. This property allows for the first time the use of such microgels for the production of pigment preparations, in particular as grinding agent for tinting pastes. In this way, it is achieved that the tinting pastes thus produced have a high pigment content while simultaneously exhibiting a low viscosity.

### EXAMPLES

Preparation of the Starting Products

Acrylate Dispersion I:

305 g of butyl glycol are weighed into a 2 l reaction vessel with a stirrer and a feed vessel and heated to 120° C. At 120° C., a mixture of 40 g of styrene, 53.3 g of butyl methacrylate, 462.3 g of lauryl acrylate, 152.4 g of 2-hydroxyethyl acrylate, 6.5 g of vinyl phosphonic acid, 41.6 g of acrylic acid and 15.1 g of tert.butyl per-2-ethylhexanoate is metered in homogeneously from the feed vessel within 2 hours. On completion of the introduction, after-polymerisation is carried out for 0.5 hours. Subsequently, a mixture of 7.2 g of butyl glycol and 1.5 g of tert.butyl per-2-ethylhexanoate is metered in within 0.1 hour. On completion of this addition, after-polymerisation is carried out for 1.5 hours. Subsequently, a mixture of 14.3 μg of dimethyl ethanol amine and 970 g of fully demineralised water is added. A stable dispersion with an acid number of 47 and a solids content of 36% (30 minutes at 180° C.) is obtained.

Acrylate Dispersion 2:

300 g of butyl glycol are weighed into a 2 l reaction vessel with a stirrer and a feed vessel and heated to 120° C. At 120° C., a mixture of 146.4 g of 2-ethylhexyl acrylate 120 g of styrene, 160 g of butyl methacrylate, 255.2 g of polypropylene glycol monomethacrylate with an average molecular weight of 350, 105 g of 4-hydroxybutyl acrylate, 7.2 g of vinyl phosphonic acid, 46.2 g of acrylic acid and 23.2 g of tert.butyl per-2-ethylhexanoate is metered in homogeneously from the feed vessel within 3 hours. On completion of the introduction, after-polymerisation is carried out for 0.5 hours. Subsequently, a mixture of 7.2 g of butyl glycol and 1.5 g of tert.butyl per-2-ethylhexanoate is metered in within 0.1 hour. On completion of this addition, after-polymerisation is carried out for 1.5 hours. Subsequently, a mixture of 18.7 g of dimethyl ethanol amine and 850 g of fully demineralised water is added. A stable dispersion with an acid number of 47 and a solids content of 41% (30 minutes at 180° C.) is obtained.

Polyurethane Dispersion (for the Application Example)

602.3 g of a polyester with a number average molecular weight of 1440 based on a dimerised fatty acid (Pripol® 1013 from Unichema) and 1,6-hexane diol with an acid number of less than 3, 56 g of dimethylol propionic acid, 306.2 g of tetramethyl xylylene diisocyanate, 241 g of methyl ethyl ketone and 0.9 g of dibutyltin dilaurate are weighed into a 6 l reaction vessel with a reflux condenser. This mixture is kept at 80° C. until the isocyanate content is 2.35%. Subsequently, 90.4 g of trimethylol propane and 23 g of methyl ethyl ketone are added and brought to an isocyanate content of <0.03% at 80° C. Subsequently, a mixture of 33.5 g of dimethyl ethanol amine and 1085 g of fully demineralised water and subsequently 1598 g of fully demineralised water are added. Following vacuum distillation, in which the methyl ethyl ketone is removed, a dispersion with a solids content of 28% (60 minutes at 120° C.) is obtained.

Polyester Dispersion (for the Application Example)

332.8 g of neopentyl glycol, 283.2 g of 1,6 hexane diol, 696 g of a dimerised fatty acid (Pripol® 1013 from Unichema) and 184.2 g of hexahydrophthalic acid anhydride are weighed into a 4 l reaction vessel with a stirrer and a packed column and heated in such a way that the column head temperature does not exceed 100° C. The maximum esterification temperature is 230° C. Cooling is carried out at an acid number of less than 10. At 150° C., 307.2 g of trimellitic acid anhydride are added and heated such that the column head temperature does not exceed 100° C. The maximum esterification temperature is 180° C. Cooling is carried out at an acid number of 30. A polyester with a calculated molecular weight of 1870 and a hydroxyl number of 83 is obtained. At a temperature below 100° C., a mixture of 42.7 g of dimethyl ethanol amine and 1350 g of fully demineralised salt is metered in and subsequently 1910 g of fully demineralised water are added. A stable dispersion with a solids content of 30% (60 minutes at 120° C.) is obtained.

Production of the Microgel Dispersions According to the Invention

Microgel Dispersion I:

834.7 g of acrylate dispersion I are weighed into a 2 l reaction vessel with a reflux condenser and 139.9 g of a commercial melamine resin (Cymel® 327 from Dyno Cytec), 1 g of dimethyl ethanol amine and 580 g of fully demineralised water are added to the batch with stirring. Heating to 95° C. and condensing at 95° C. is carried out for 7 hours. Subsequently, cooling is carried out and 14 g of dimethyl ethanol amine are added to the batch.

A stable dispersion with a solids content of 24% (60 minutes at 120° C.) is obtained. A sample of this dispersion diluted with tetrahydrofuran exhibits a strong turbidity.

Microgel Dispersion 2:

830.7 g of acrylate dispersion 2 are weighed into a 2 l reaction vessel with a reflux condenser and 162.3 g of a commercial melamine resin (Cymel®) 327 from Dyno Cytec) and 800 g of fully demineralised water are added to the batch with stirring. Heating to 94° C. and condensing at 94° C. is carried out for 10 hours. Subsequently, cooling is carried out and 11.9 g of dimethyl ethanol amine are added to the batch.

A stable dispersion with a solids content of 24% (60 minutes at 120° C.) is obtained. A sample of this dispersion diluted with tetrahydrofuran exhibits a strong turbidity.

Use of the Microgel Dispersions According to the Invention

Application Example 1:

To produce a metallic water-based paint, 107.1 g of the polyurethane dispersion and 312.5 g of the microgel dispersion I according to the invention, a mixture of 50 g of polyester dispersion, 0.4 g of dimethyl ethanol amine and 35 g of fully demineralised water, 16.6 g of a commercial melamine resin (Cymel®) 327 from Dyno Cytec), 42.9 g of a commercial aluminium bronze which had previously been kneaded to form a dough in 56.2 g of butyl glycol and 31.6 g of N-butanol and a mixture of 24.6 g of a commercial acrylate thickener (Latekoll® D from BASF) and 46 g of fully demineralised water was processed to form a paint. The pH is adjusted to 8.00 to 8.30 using dimethyl ethanol amine and a viscosity (measured at 1000 s⁻¹) of 100 mPas is adjusted using fully demineralised water.

Application Example 2:

The procedure of example 1 is repeated. However, the 312.5 g of microgel dispersion I are replaced by 312.5 g of the polymer dispersion 2 according to the invention.

Visual Examination:

The aqueous base coats produced according to the application examples described above are applied by spray application to sheet steel of a size of 70×70 cm in an air-conditioned spray booth in such a way that a dry layer thickness of 15-18 μm is obtained. After a ventilation time of 5 minutes, the sheet metal panels are provided with a commercial motor vehicle clear coat with a dry layer thickness of 40-45 μm and the layers are subsequently stoved at 140° C. for 30 minutes.

By using the microgel dispersions according to the invention, coatings are obtained which are characterised by an excellent aluminium orientation, no clouding and by excellent non-sagging properties.

1. Emulsifier-free microgel dispersed in the aqueous phase obtainable by
a) producing a polyacrylate (A) in the presence of at last one compound (B) exhibiting a phosphonic acid group, the polyacrylate (A) exhibiting at least one hydroxyl group and at least one carboxyl group;
b) crosslinking, in the aqueous phase, of the reaction mixture originating from step
a) with an aminoplast resin (C);
characterised in that the reaction mixture originating from step b) is not subjected to any subsequent emulsion polymerisation.

2. Microgel according to claim 1 wherein the polyacrylate (A) resulting from step a) is subjected, before step b), to an emulsion polymerisation with at least one monomer compound (D) which contains at least one free radical polymerisable double bond.

3. Microgel according to claim 1 wherein the polyacrylate (A) is obtainable by the polymerisation
of a monomer (i) with at least one polymerisable double bond and at least one hydroxyl group;
of a monomer (ii) with at least one polymerisable double bond and at least one carboxyl group; and
of a monomer (iii) without hydroxyl group and without carboxyl group with at least one polymerisable double bond.

4. Microgel according to claim 1 wherein compound (B) is an adduct of an alkyl phosphonic acid with a compound containing epoxy groups.

5. Emulsifier-free microgel dispersed in the aqueous phase obtainable by
a) a producing a polyacrylate (E) by the copolymerisation
of a monomer (i) with at least one polymerisable double bond and at least one hydroxyl group;
of a monomer (ii) with at least one polymerisable double bond and at least one carboxyl group; and
of a monomer (iv) with at least one polymerisable double bond and at least one phosphonic acid group;
b) crosslinking, in the aqueous phase, of the reaction mixture originating from step a) with an aminoplast resin (C);
characterised in that the reaction mixture originating from step b) is not subjected to any subsequent emulsion polymerisation.

6. Microgel according to claim 5 wherein the polyacrylate (E) resulting from step a) is subjected, before step b), to an emulsion polymerisation with at least one monomer compound (D) which contains at least one free radical polymerisable double bond.

7. Microgel according to claim 5 wherein the copolymerisation is carried out in the presence of an additional monomer (iii) without hydroxyl group and without carboxyl group, which monomer exhibits at least one polymerisable double bond.

8. Microgel according to claim 3 wherein the monomer (i) is selected from the group of hydroxyethyl(meth)acrylate, hydroxypropyl(meth)acrylate, hydroxybutyl(meth)acrylate and caprolactone esterified on the basis of hydroxy(meth)acrylate.

9. Microgel according to claim 3 wherein the monomer (ii) is selected from the group of acrylic acid and methacrylic acid.

10. Microgel according to claim 3 wherein the monomer (iii) is selected from the group of acrylic (meth)acrylic acid esters free from hydroxyl groups, and styrene.

11. Microgel according to claim 5 wherein the monomer (iv) is vinyl phosphonic acid.

12. Microgel according to claim 1 wherein the aminoplast resin is a melamine resin.

13. Microgel according to claim 2 wherein at least one monomer compound (D) contains no hydroxyl groups.

14. Microgel according to claim 13 wherein, additionally, at least one monomer compound (D) exhibits at least one hydroxyl group.

15. Microgel according to claim 1 wherein it exhibits an acid number between 10 and 45 mg KOH/g.

16. A method for the production of a coating, comprising applying a dispersion containing an emulsifier-free microgel of claim 1 on a surface of a substrate to obtain a coating.

17. A method according to claim 16 for the production of wherein the coating is a base coat.

18. A method according to claim 16, wherein the microgel, is between 20 wt % and 85 wt %, of a solid content of the coating.

19. The method according to claim 16, wherein the microgel is between 20 wt % and 65 wt % of a solid content of the coating.

20. Microgel according to claim 2 wherein the polyacrylate (A) is obtainable by the polymerisation
of a monomer (i) with at least one polymerisable double bond and at least one hydroxyl group;
of a monomer (ii) with at least one polymerisable double bond and at least one carboxyl group; and
of a monomer (iii) without hydroxyl group and without carboxyl group with at least one polymerisable double bond.
